(19) United States
(12) Patent Application Publication
(10) Pub. No.: US 2006/0050285 A1
(43) Pub. Date: Mar. 9, 2006

(54) Position Encoder with Directional Output

(76) Inventor: Keith Stanley Weller, Cambridge (GB)

Correspondence Address: MR. KEITH STANLEY WELLER, 203 GREEN END ROAD, CAMBRIDGE, CB4-1RJ, GB

(21) Appl. No.: 11/161,965

(22) Filed: Aug. 24, 2005

(30) Foreign Application Priority Data
Sep. 6, 2004 (GB) 0419683.8

(51) Int. Cl. G01B 11/14

(52) U.S. Cl. 356/616

(57) ABSTRACT

A method for measuring the position and direction of movement of an object having a simple alternating pattern of light and dark markings using radiant energy where the object is subject to extraneous interfering radiation. The method includes the steps of Illuminating the alternating pattern of light and dark markings with radiation from two or more emitters where the radiation from each emitter is modulated at the same frequency but differing phase, using the modulation component present in the detected signal to separate it from signals caused by interfering radiation, and then using the amplitude and phase information present in this separated signal to determine the position and direction of movement of the object.

### BACKGROUND OF THE INVENTION

### FIELD OF THE INVENTION

This invention relates to a non-contact method for measuring the position and direction of movement of an object.

It is well known in the prior art that the movement, both linear and rotary, of an object may be measured without making physical contact with the object by illuminating it with a suitable form of radiant energy and then analyzing the variation in intensity (i.e. modulation) present in the radiant energy that was either reflected or transmitted by the markings on the object.

The generic class of devices known as ‘optical encoders’ use electromagnetic energy (either visible or invisible to the human eye) as the illuminating radiant energy source, and a pattern of light and dark markings attached to the object to cause the intensity modulation. Typically, one or more light emitters will illuminate the pattern, and one or more optical detectors will be used to detect the light either reflected or transmitted by the pattern. The detected light will be modulated in intensity by the movement of the light and dark markings (or increments) through the detector field of view, and hence the detected signal may be used to measure these incremental movements.

In this text, a ‘light marking’ is a region of the pattern that is either more reflective or transmissive in comparison to a ‘dark marking’ for the particular form of radiation used.

The above example describes the use of electromagnetic radiation in the optical spectrum as the radiation source, but other forms of radiant energy may also be used, such as electromagnetic radiation outside of the optical spectrum, acoustic waves, magnetic fields and electrostatic fields. For simplicity however, this text will concentrate on the use of optical electromagnetic radiation.

In its most basic form, a single light source and detector in conjunction with a simple alternating light and dark pattern can only provide information about the speed of movement (i.e. the increment rate) and not the direction of movement.

To be able to indicate the position of the moving object relative to some starting position (often referred to as the ‘index’), an encoder must be able to not only detect these incremental movements, but also in which direction they occur. By counting the increments (either positive or negative, depending on the direction) since the index was last detected the absolute position relative to the index may be calculated.

The index position is typically detected with a separate optical marker and detector placed on the object. For a rotating object the index typically marks a complete revolution.

To provide the directional information, a common solution is to use two simple alternating light and dark patterns displaced relative to each other, and at least two optical detectors focused on each pattern. The phase relationship between the electrical signals produced by these two detectors may then be used to deduce the direction of movement. A disadvantage of this approach is the requirement for this more complex pattern to be attached to the object, and the extra cost of using two optical detectors (and associated electronics) rather than one.

U.S. Pat. No. 6,552,329 discloses a method which overcomes the above disadvantages, i.e. the requirement of a more complex marking pattern and two or more detectors, by attaching a simple grid to the moving object, illuminating this grid with radiation from two or more emitters in pulses, detecting the light transmitted through the grid with a single detector, and then separating the components present in this signal from each of the transmitters to deduce the direction of movement.

A limitation of U.S. Pat. No. 6,552,329 is the necessity to attach a special optically transmissive grid to the object. Some objects, such as roulette wheels and gear wheels, already have an intrinsic pattern of light and dark regions, namely the colored numbers around the roulette wheel or the teeth of the gear wheel, and it may be costly and/or impractical to attach a special grid to these objects. The grid may also be susceptible to damage or contamination with oil or dirt, such as if attached to a gear wheel.

Another problem commonly encountered with optical encoding systems and not addressed by U.S. Pat. No. 6,552,329 is the need to eliminate background and other extraneous light sources adding to and hence interfering with the detected signal. Housing the optical components in a lightproof enclosure is the typical solution to this problem. However it is sometimes not practical to block out extraneous light sources in this way, for example when the marking pattern is intrinsic to the object and the object is open to an uncontrolled light environment, such as a roulette wheel in a casino.

### BRIEF SUMMARY OF THE INVENTION

The present invention relates to a non-contact method for measuring the position and direction of movement of an object having a simple alternating pattern of light and dark markings or regions (either intrinsic to the object, or specially attached to the object) using radiant energy, and where said object is subject to interfering radiant energy.

An advantage of the present invention is its ability to work using radiant energy reflected from a simple pattern of light and dark markings intrinsic to the object.

Another advantage of the present invention is its ability to work in the presence of extraneous interfering radiant energy.

A further advantage of the present invention is its ability to work with weakly reflected or transmitted radiant energy, such as where the object is at a significant distance from the emitters and detectors, or the contrast between light and dark markings is poor.

A yet further advantage of the present invention is the minimal number of radiant energy detectors required.

According to the invention, there is provided a method capable of achieving the aforementioned advantages comprising the steps of:

(1) Illuminating the alternating pattern of light and dark markings or regions on the object with radiation from two or more emitters, where the radiation from each of the emitters is modulated with substantially the same frequency but distinct phase with respect to each other, and the regions illuminated by each emitter are also spatially distinct;

(2) detecting the modulated radiation either reflected or transmitted from the alternating pattern with one or more detectors to produce electrical signals;

(3) using the modulation component present in these signals to separate them from signals produced by extraneous interfering radiation impinging on the detectors; and

(4) determining the position and direction of movement of the object from these separated signals.

The information present in the separated signals obtained by the method outlined above may also be used to identify an index marker in the pattern, where this index takes the form of a break in the otherwise regular alternating pattern of light and dark markings or regions on the object.

Other objects, features, and advantages of the invention will become apparent from the following detailed description of the invention with reference to the accompanying drawings.

The embodiment of the invention described herein is not intended to be limited to the details shown, since various modifications and structural changes may be made to these details without departing from the spirit of the invention and within the scope and range of equivalents of the claims.

### BRIEF DESCRIPTION OF THE DRAWINGS

FIG. 1 shows a representation of the principle components required for one embodiment of the method.

FIG. 2 through FIG. 5 show the electrical inputs to the emitters and filtered output signal from the detector of FIG. 1 for various positions of the alternating light and dark pattern.

### DETAILED DESCRIPTION OF THE INVENTION

An example of an application where the present invention may be advantageously used is now described. The example is in measuring the position and rotational direction of a roulette wheel. A roulette wheel has an intrinsic pattern of alternating red and black regions in the form of the numbers around the wheel perimeter, and the alternating pattern is often broken with a single green marker, which may be used as an index, as described later. By using the method disclosed in this text, it is possible to attach a sensor to the wheel that can measure its position and direction of motion without the need to attach a special sensing element to the moving part of the wheel, or the need to shield the sensor from the various ambient light sources in the casino.

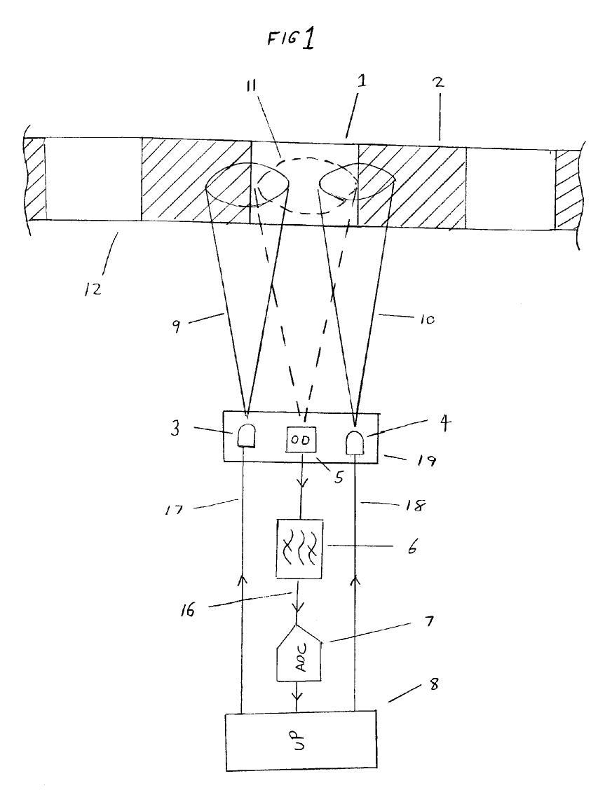

A schematic representation of the significant elements in this example is shown in FIG. 1, 12 is the alternating pattern of light 1 and dark 2 regions (i.e. the red and black numbers) on the object. The pattern may move either right to left or left to right in front of the ‘optical transceiver’ assembly 19, which consists of two optical emitters 3, 4 and a single optical detector 5. In this example, a ‘light’ marking means more reflective than a ‘dark’ marking, so it would be preferable (but not essential) for the emitters to illuminate the pattern with light in the red part of the visible spectrum, thereby maximizing the contrast between the red and black regions. If red illuminating light is used, the green number on the wheel will also appear dark in comparison to the red numbers, and thus be detected by the system as a break in the regular alternating light and dark sequence, i.e. as an extended dark region, and thus be identifiable to the system as the index position on the wheel. A red filter placed over the optical detector would further enhance the contrast between light and dark regions in the detector output, and also serve to attenuate the signal produced by broader spectrum light impinging on the detector that might otherwise cause the detector to saturate.

The beam patterns cast on the target by the emitters 3, 4 are shown as 9 and 10 in FIG. 1. The field of view of the optical detector 5 is shown as 11, which, as shown, should preferably cover an area restricted to the size of each light or dark region of the pattern 12 in order to provide maximum contrast in the detected signal between light and dark regions, and also to limit the amount of ambient light received by the detector and thus reduce the likelihood of it being saturated by strong ambient light.

A bandpass filter 6 preferably filters the electrical signal produced by the optical detector. The intensity of the light transmitted by 3, 4 is preferably modulated at the centre frequency of this filter. Typically, the modulation is in the form of square waves on emitter drive signals 17, 18 produced by the microprocessor 8. Using a narrow band filter centered at the modulation frequency substantially removes much of the signal component in the received signal 16 produced by extraneous interfering light impinging on the detector 5, so the system is substantially responsive only to the light produced by the emitters 3, 4. Furthermore, if the filtered signal 16 is digitized by the analog to digital converter (ADC) 7, the microprocessor 8 can employ signal-processing techniques to further enhance the signal to noise performance. Since the microprocessor generates the modulation frequency, a digital ‘lock-in’ (synchronous demodulator) type detector or a very narrow band digital filter may be implemented in software to provide very high signal to noise improvements.

Additionally, the presence of a known modulation frequency in the detected signal allows the system to separate weak signals reflected or transmitted by the pattern from much stronger interference signals, so the system is able to reliably detect movement of a pattern at a significant distance from the sensor, or where the contrast between the light and dark regions on the pattern is so low that the variation in intensity in the detected signal caused by the pattern movement would otherwise be lost in noise.

Note that although filter 6 is shown in FIG. 1, it is not an essential feature and could be eliminated for cost reasons or where there is minimal background light interference.

Similarly, the ADC 7 could be replaced with a simple comparator circuit.

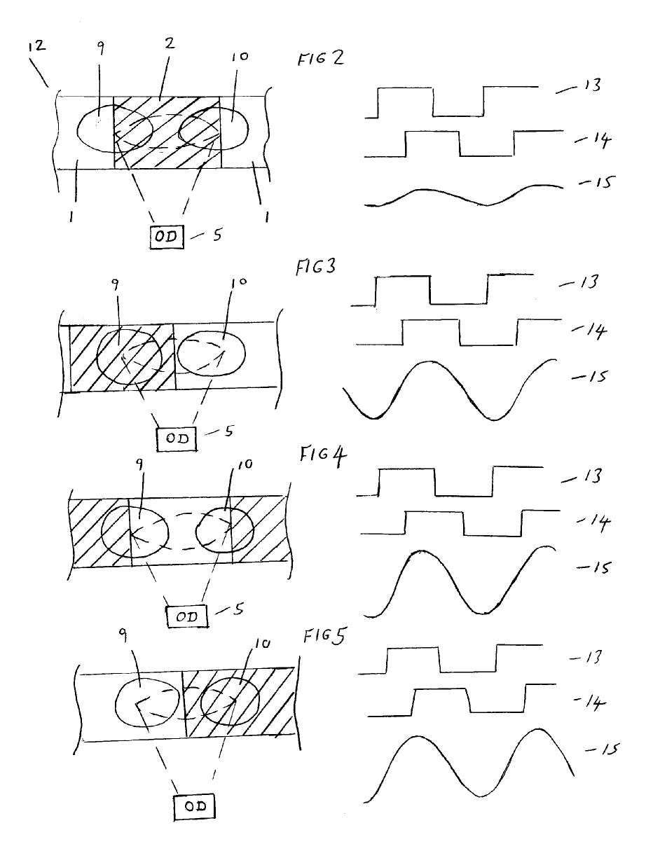

FIG. 2 through FIG. 5 show how the invention is able to detect the direction of rotation from a simple alternating light and dark pattern. In these figures, 13 and 14 shows the modulation signal applied to optical emitters 3 and 4 respectively, and 15 shows the typical waveform at output 16 of the bandpass filter 6.

Introducing a phase shift between signals 13, 14 means that the phase shift present in the detected signal is indicative of which of emitter is being reflected most strongly at a given moment.

Typically a phase difference of 90 degrees will be used as shown (i.e. quadrature phase) but other values may be used as long as they are sufficiently distinct from one another to be separable by the rest of the signal processing chain.

FIG. 2 shows the signals produced when the dark region is central to the optical detector 5. The amplitude of the detected signal 15 is at a minimum. As the pattern moves from right to left, the light from the right emitter 10 will be strongly reflected and fall into the field of view of the optical detector 5. This situation is shown in FIG. 3. Detected signal 15 is now larger than it was in FIG. 2, and predominantly in phase with emitter drive signal 14.

When the light region is central as shown in FIG. 4, the received signal is maximum and in phase with the sum of drive signals 13, 14.

As the dark region moves under transmitted beam pattern 10 and the light region under beam pattern 11, shown in FIG. 5, the received signal will decrease in amplitude somewhat and move in phase towards drive signal 13.

The sequence described above will be reversed if the pattern moves left to right, hence by measuring both the phase and amplitude of the received signal the system is able to determine in which direction the pattern is moving past the optical transceiver.

As noted previously, a green region introduced into the otherwise regular alternating red/black sequence will also appear dark if predominantly red illuminating light is used, and hence this will be detectable by the system as two consecutive dark cycles in the received signal 16.

It should be noted that the signals depicted in FIG. 2 through FIG. 5 are ideal in the sense that there is no phase shift introduced by the bandpass filter 6. In practice, filter 6 may introduce a phase shift dependent on the relationship between the modulation frequency and the centre frequency of the filter. The modulation frequency can be kept very stable by the microprocessor if it is derived from a crystal oscillator. The stability of the filter centre frequency will be largely dominated by the temperature stability of the filter analog components, but since the system is only concerned with detecting the direction of phase shift and not its absolute value, temperature drift is unlikely to present a problem. Also, in a practical system, the microprocessor can make adjustments to the modulation frequency over time to track the filter centre frequency and hence maximize received signal strength and minimize filter phase shift drift.

Although the duty cycle of the drive signals 13, 14 shown in FIG. 2 through FIG. 5 are shown as approximately 50%, other duty cycles may be used as long as there is a phase difference between them.

Using phase shifted emitter drive signals at a single modulation frequency to convey the directional information in the manner described above allows the detector signal path to have a very narrow bandwidth and hence substantially reduce interference from extraneous light sources, and also enables the system to work reliably with weak detected signals.

Using two emitters and a single detector (and hence a single set of receiver path signal processing components) as described in the embodiment above minimizes component cost and circuit complexity.

What is claimed is:

1. A method for determining the position and direction of movement of an object having an alternating pattern of light and dark regions, comprising the steps of:
Illuminating said alternating pattern of light and dark regions on said object with modulated radiation emitted from two or more emitters where said modulated radiation emitted by each of said emitters has substantially the same frequency but distinct phases with respect to each other, and the regions illuminated by each of said emitters are also spatially distinct;
detecting said illuminating modulated radiation either reflected or transmitted by said alternating pattern of light and dark regions with one or more detectors, wherein each detector produces an electrical signal in response to the radiation impinging upon it; using said modulation present in said electrical signals from said one or more detectors to separate the signals produced by said illuminating modulated radiation from the signals produced by extraneous interfering radiation impinging on said detectors; and determining the position and direction of movement of the object from said separated signals.

2. The method of claim 1 wherein said emitters emit electromagnetic radiation with a wavelength chosen to enhance the contrast between the light and dark regions on said alternating pattern.

3. The method of claim 2 wherein said detectors are electromagnetic detectors with an electrical response matched to the wavelength emitted by said emitters.

4. The method of claim 1 wherein the detected illuminating radiation is reflected by said alternating pattern.

5. The method of claim 1 further comprising a step for determining the position of an index, comprising:
using said separated signals to determine the position of said index, where said index is defined as an interruption in the regularity of the otherwise regular alternating pattern of light and dark regions.

6. The method of claim 1 wherein said object is a roulette wheel.
